(19) United States
(12) Patent Application Publication
(10) Pub. No.: US 2016/0097935 A1
(43) Pub. Date: Apr. 7, 2016

(54) DISPLAY APPARATUS

(71) Applicant: INNOLUX CORPORATION, Miaoli County (TW)

(72) Inventors: LIEN-CHEN CHIEN, Miaoli County (TW); SHIH-YUAN FENG, Miaoli County (TW)

(21) Appl. No.: 14/873,681

(22) Filed: Oct. 2, 2015

(30) Foreign Application Priority Data
Oct. 3, 2014 (TW) 103217696

(51) Int. Cl. G02B 27/22; F21V 8/00; H04N 13/04

(52) U.S. Cl. CPC G02B 27/2278; H04N 13/04; H04N 13/0452; H04N 13/0454; G02B 6/0073; G02B 6/0068; G02B 6/0091; G02B 6/0076; G02B 6/0093

(57) ABSTRACT

A display apparatus has a first back bezel with a first side; a first light guide plate disposed above the first rear bezel; a first light bar disposed above the first side of the first back bezel, and the first light bar disposed between the first light guide plate and the first back bezel, and the first light bar including a plurality of first light-emitting diodes, a length of each of the first light-emitting diodes is L, a distance of two farthest first light-emitting diodes of these first light-emitting diodes is W1; and a display panel disposed on the first light guide plate, the display panel has a display area with a second side, the second side is adjacent to the first side, and a length of the second side is W2, W2 is smaller than W1 and the difference between W1 and W2 is great than L.

### FIELD OF THE INVENTION

The present invention relates to a display apparatus, and more particularly, to a display apparatus capable of displaying three-dimensional images.

### BACKGROUND OF THE INVENTION

Generally, a conventional display apparatus is enabled to display images in its image field by the use of light emitted from its light bars.

However, as the conventional display apparatus can only display two-dimensional images, following the advance of modern three-dimensional visualization technology, the attractiveness and excitement of the viewing experience from those two-dimensional image can no longer satisfy the expectation of modern consumers. Therefore, it is in need of an improved display apparatus.

### SUMMARY OF THE INVENTION

In view of the disadvantages of prior art, the primary object of the present invention is to provide a display apparatus, capable of displaying three-dimensional image by the use of light emitted from its light bars, while being designed with a 2D/3D switching function, so that the problem of the conventional display apparatus which can only display two-dimensional image can be overcome.

To achieve the above object, one of the embodiment of the present invention provides a display apparatus, comprising: a first back bezel with a first side; a first light guide plate, disposed above the first back bezel; a first light bar, disposed above the first side of the first back bezeland also disposed between the first light guide plate and the first back bezel; and a display panel, comprising a display area with a second side, while being disposed above the first light guide plate; wherein, the first light bar includes a plurality of first light-emitting diodes, and at least one of the first light-emitting diodes is formed with a length L, two of the first light-emitting diodes that are the disposed farthest apart from each other by a distance W1; and the second side of the display area is disposed adjacent to the first side, and a length of the second side is W2, W2 is smaller than W1, and the difference between W1 and W2 is greater than L.

Operationally, light emitted from the plural first light-emitting diodes is projected to the first light guide plate where it is being guided to the display panel for enabling a three-dimensional image to be displayed on the display panel, and as the distance W1 between the two first light-emitting diodes that are spaced farthest apart from each other is designed to be larger than the length W2 of the second side of the display area in the display panel, the periphery of the display panel can be fully illuminated by the plurality of the first light-emitting diodes and thus the brightness uniformity of the display apparatus is improved.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is an exposed diagram showing a display apparatus according to an embodiment of the present invention.

FIG. 2 is a schematic view of a first light bar used in one of the embodiment of the present invention.

FIG. 3 is a schematic view of a display panel used in one of the embodiment of the present invention.

FIG. 4 is a partial schematic view of a first light bar, a display panel, a frame and a first back bezel.

FIG. 5 is a three-dimensional view showing a partial cross section of a display apparatus according to an embodiment of the present invention.

FIG. 6 is a schematic pattern with a plurality of stripes showing in a display apparatus of the present invention.

FIG. 7 is a schematic view of a stripe shown in FIG. 6.

FIG. 8 is a three-dimensional view showing a partial cross section of a display apparatus according to another embodiment of the present invention.

FIG. 9 is a three-dimensional view showing a partial of a second back bezel in one of the embodiment of the present invention.

FIG. 10 is a partial cross sectional view of a display panel and a first light guide plate in one of the embodiment of the present invention.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

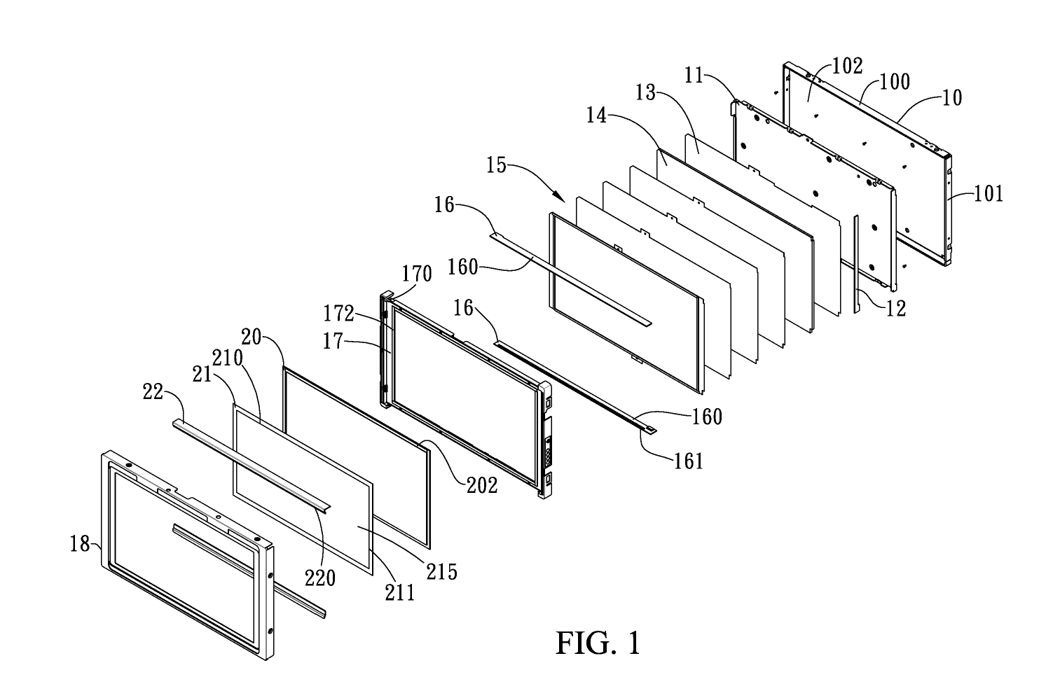

Please refer to FIG. 1, which is an exposed diagram showing a display apparatus according to an embodiment of the present invention. As shown in FIG. 1, a display apparatus of the present invention comprises: a first back bezel 10, a first light bar 16, a first light guide plate 20 and a display panel 21.

The first back bezel 10 is formed with a first side 100; the first light bar 16 is disposed above the first side 100 of the first back bezel 10; and the first light bar 16 is disposed between the first light guide plate 20 and the first back bezel 10.

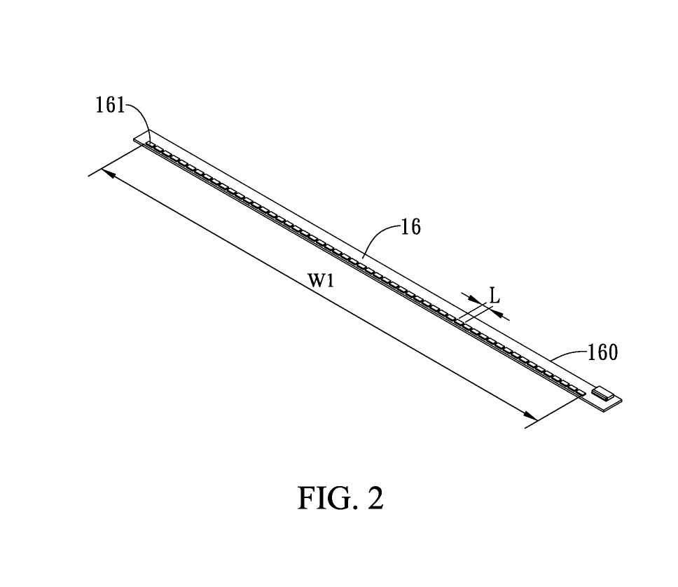

Please refer to FIG. 2, which is a schematic view of a first light bar used in the present embodiment. In FIG. 2, the first light bar 16 includes a first bar-shape substrate 160 and a plurality of first light-emitting diodes 161. The plurality of the first light-emitting diodes 161 are disposed on the first bar-shape substrate 160, whereas at least one of the plurality of the first light-emitting diodes 161 is formed with a length L, and two of the plurality of the first light-emitting diodes 161 that are space farthest apart form each other is spaced from each other by a distance W1.

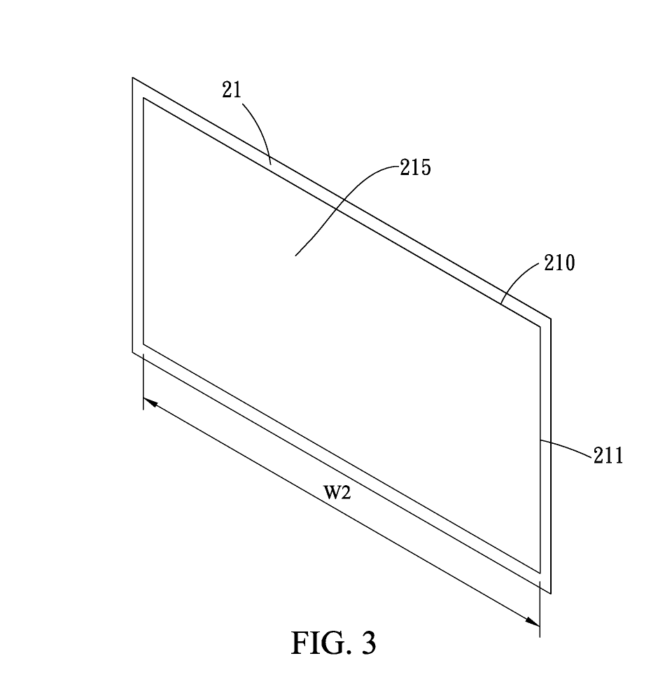

Please refer to FIG. 3, which is a schematic view of a display panel used in the present ambodiment. In FIG. 3, the display panel 21 is formed with a display area 215 which includes a second side 210 and a fourth side 211. The second side 210 is disposed adjacent to the first side 100 of the first back bezel 10 and is formed with a length W2 that is smaller than W1, and the difference between W1 and W2 is great than L. That is, the distance W1 measured between the two first light-emitting diodes 161 that are spaced farthest apart form each other exceeds the display area 251 at least larger than the length L. It is noted that the display area 215 refers to an area in the display panel 21 that is used for image displaying.

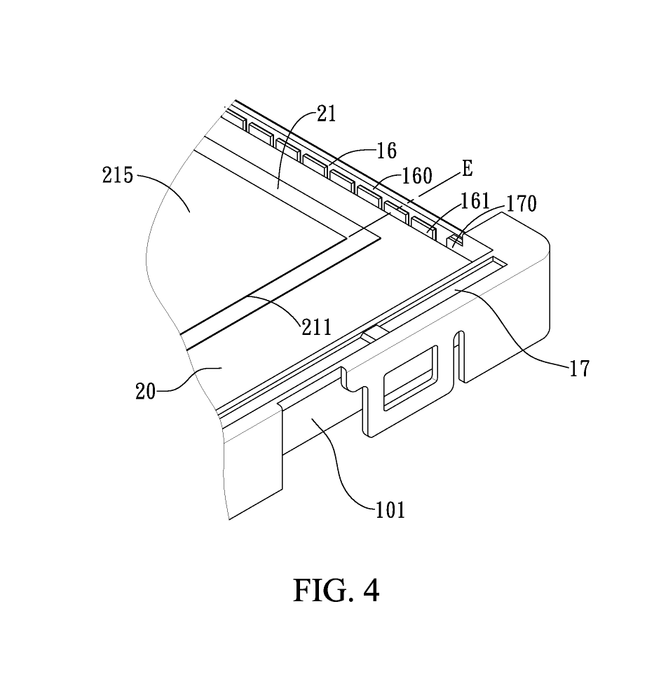

As shown in FIG. 1 and FIG. 4, the first back bezel 10 is further comprising a third side 101 connected to the first side 100 at a position adjacent to the fourth side 211, and thereby, since W2 is smaller than W1, there will be at least one first light-emitting diodes 161 to be disposed for enabling a portion thereof to be positioned between the third side 101 and the fourth side 211.

Preferably, the at least one first light-emitting diodes 161 is disposed outside an extension line E of the fourth side 211 of the display area 215. Moreover, the at least one first light-emitting diodes 161 that is disposed outside an extension line E is used for providing supplemental lighting to the periphery of the display panel 215, so as to improve the brightness uniformity of the display apparatus.

In the embodiment shown in FIG. 1 and FIG. 4, the display apparatus further comprises a frame 17, that is disposed between the first light guide plate 20 and the first back bezel 10 while being integrated with the first back bezel 10. Moreover, the frame 17 has at least one corner with a projection 170, whereas the projection 170 is positioned between the first bar-shape substrate 160 and the first light guide plate 20, and also the thickness of the projection 170 is not smaller than the thickness of the first light-emitting diodes 161. By forming the projection 170 thicker than the plurality of the first light-emitting diodes 161, the plurality of the first light-emitting diodes 161 can be prevented from colliding to the first light guide plate 20 and thus being damaged by the collision. Thus, the overall performance of the display apparatus can be ensured.

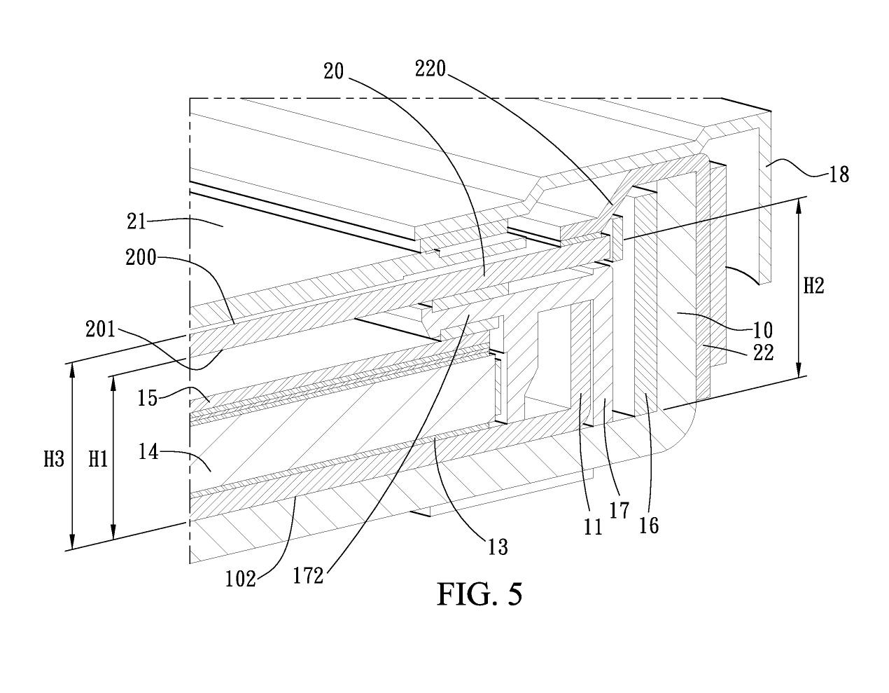

Please refer to FIG. 5, which is a three-dimensional view showing a partial cross section of a display apparatus according to an embodiment of the present invention. The frame 17 further comprises a supporting portion 172 and the first light guide plate 20 disposed thereon, a vertical distance H1 between a lower surface 201 of the first light guide plate 20 and a bottom surface 102 of the first back bezel 10 is not larger than a vertical distance H2 between a horizontal center line of the first light-emitting diodes 161 and the bottom surface 102, while enabling a vertical distance H3 measured between an upper surface 200 of the first light guide plate 20 and the bottom surface 102 of the first back bezel 10 to be larger than the vertical distance H2 measured between the horizontal center line of the plural first light-emitting diodes 161 and the bottom surface 102. Thereby, light emitted from the plural first light-emitting diodes 161 can be projected into the first light guide plate 20. Preferably, the plurality of the first light-emitting diodes 161 of the first light bar 16 should be positioned aligning to the center of a light incident side 202 of the first light guide plate 20.

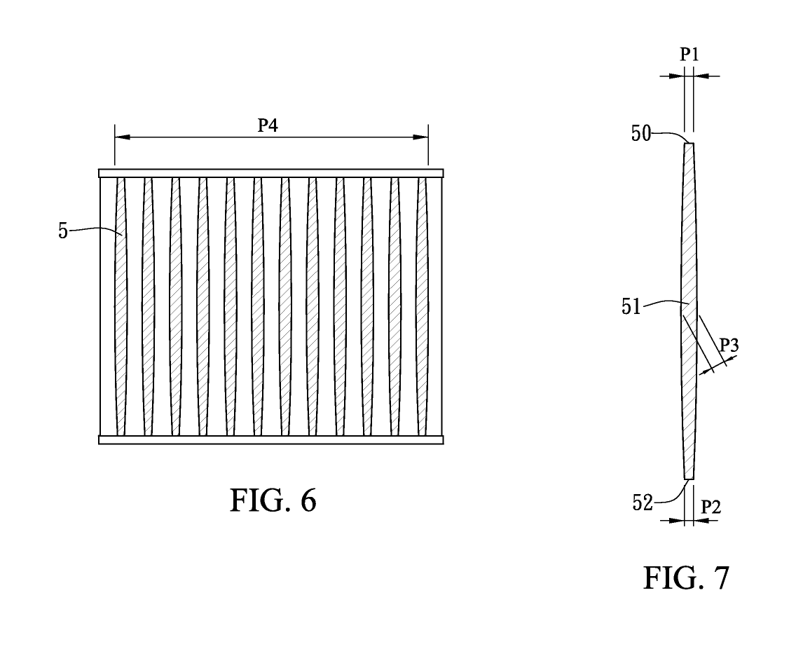

Please refer to FIG. 6, which is a schematic pattern with a plurality of stripes showing in a display apparatus of the present embodiment. As shown in FIG. 6, there are a plurality of stripes 5 being disposed on the lower surface 201 of the first light guide plate 20. It is noted that the first light guide plate 20 can be a light guide plate having a plurality of stripes 5 formed on its lower surface 201. As shown in FIG. 7, each stripe 5 is configured with a first end 50 and an opposite second end 52, whereas the first end 50 is formed with a width P1 while the second end 52 is formed with a width P1. Moreover, each stripe 5 is formed with a middle area 51 of a width P3. In this embodiment, P1<P3, and P2<P3.

Generally, the first and the second ends 50, 52 of each stripes on the first light guide plate 20 that are disposed closer to the first light bar 16 are narrower than the middle areas of the stripes 5 that are disposed away from the first light bar 16. By the aforesaid design, the poor light extraction efficiency in the middle areas of equal-width design can be improved, and thus the overall light extraction uniformity is enhanced.

In FIG. 6, the two stripes 5 that are the disposed farthest apart from each other in the plurality of stripes 5 are spaced apart from each other by a distance P4, while the two first light-emitting diodes 161 that are the disposed farthest apart from each other in the plurality of the first light-emitting diodes 161 are spaced apart from each other by a distance W1, and W1>P4. Thereby, the light extraction uniformity of the display apparatus is even more enhanced and also the mura effect is prevented.

In the embodiment shown in FIG. 1, the display apparatus further comprises a second back bezel 11, which is disposed above the first back bezel 10. It is noted that the second back bezel 11 can be either integrally formed with the first back bezel 10, it can be formed as an independent part separately from the first back bezel 10. Moreover, the use of the second back bezel 11 can be optional, i.e. the display apparatus of the present embodiment can perform well with only the first back bezel.

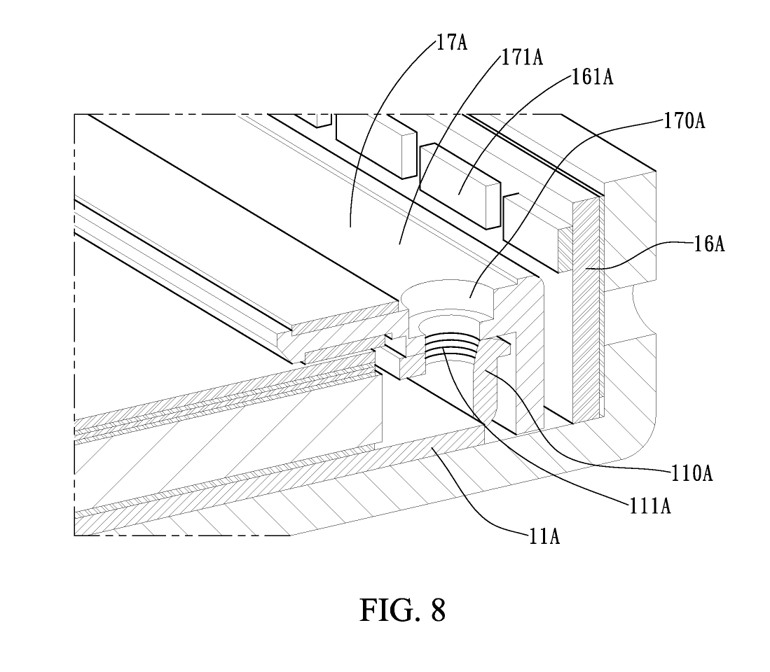

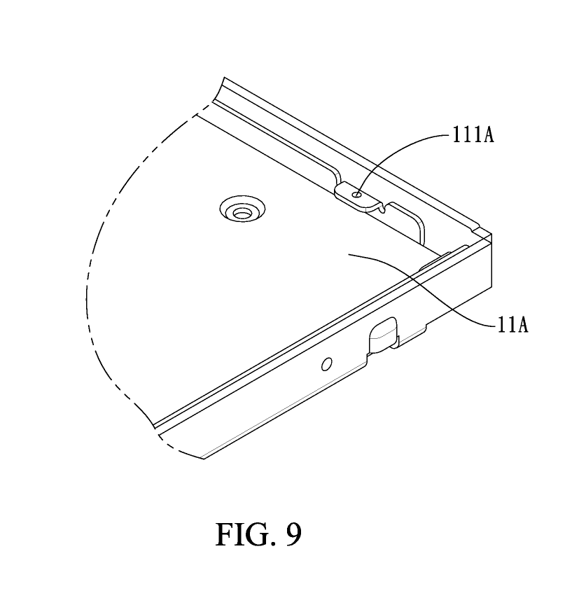

Please refer to FIG. 8, which is a three-dimensional view showing a partial cross section of a display apparatus according to another embodiment of the present invention. In FIG. 8, the second back bezel 11A is formed with at least one support base 110A. As shown in FIG. 9, the support base 110A is formed with a fixing hole 111A, and in this embodiment, the fixing hole 111A can be a screw hole, while the support base 110A can be formed with a “C”-shaped cross section.

The supporting portion 171A of the frame 17A is formed with a via hole 170A at a position corresponding to the fixing hole 170A, by that a fixing element can be arranged boring through the via hole 170A to be fixed to the fixing hole 111A, and thereby, the supporting portion 171A of the frame 17A can be fixed and positioned to the second back bezel 11A.

By the use of the support base 110A, the frame 17A is supported and disposed at a specific height. Moreover, since the first light guide plate 20 is disposed above the supporting portion 171A of the frame 17A, the first light-emitting diodes 161A of the first light bar 16 can be arranged aligning to the light incident side 202 of the first light guide plate 20.

For those embodiments without the second back bezel or those having the second back bezel integrally formed with the first back bezel, the first panel can be further configured with such support base as a component thereof. Consequently, the frame is mounted to the first back bezel in a similar way that the fixing element is arranged to be fixed to the fixing hole through the via hole.

Also shown in FIG. 1, the display apparatus further comprises a second light bar 12, which is disposed above the third side 101 of the first back bezel 10.

In addition, the display apparatus of the present embodiment can further comprises a second light guide plate 14, which can be disposed at a position between the first back bezel 10 and the first light guide plate 20 while allowing at least one end of the second light guide plate 14 to be disposed corresponding to the second light bar 12. Thereby, light from the second light bar 12 can be guided by the second light guide plate 14 and thus projected to the first light guide plate 20. Preferably, the second light guide plate 14 can be a two-dimensional light-guiding element.

As the first light bar 16 and the second light bar 12 are arranged respectively corresponding to the first light guide plate 20 and the second light guide plate 14, while the second light guide plate 14 is disposed between the first back bezel 10 and the first light guide plate 20, the vertical distance measured between the horizontal center line of the first light bar 16 and the bottom surface 102 is larger than the vertical distance measured between the horizontal center line of the second light bar 12 and the bottom surface 102.

Moreover, the display apparatus of the present embodiment further comprises a reflector 13, which is disposed between the second light guide plate 14 and the first back bezel 10. It is noted that the reflector is provided for reflecting light emitted from the second light bar 12. In an embodiment, the reflector 13 can be replaced by at least one optical film.

In addition, the display apparatus of the present embodiment further comprises an optical film set 15, which is disposed between the first light guide plate 20 and the second light guide plate 14. It is noted that the optical film set can be composed of a plurality of optical films or at least one optical films, whereas each optical film can be the composition of at least one diffusion sheet or a plurality of lens sheets.

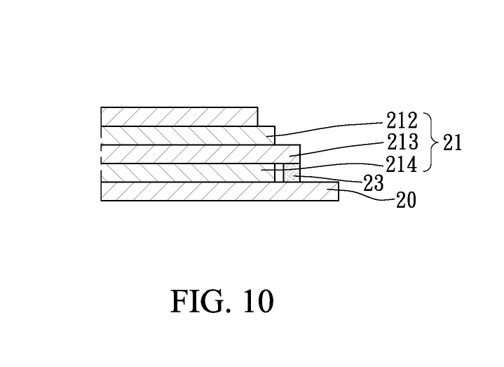

Please refer to FIG. 10, which is a partial cross sectional view of a display panel and a first light guide plate in an embodiment of the present invention. In FIG. 10, the display panel 21 is disposed on the first light guide plate 20, and comprises at least a color filter 212, a thin-film transistor 213 and a polarizer 214. In addition, there can be an optical clear adhesive 23 sandwiched between the display panel 21 and the first light guide plate 20, by that the display panel 21 can be adhered to the first light guide plate 20 while enabling the display area 215 to be fixedly aligning to the stripes 5. Preferably, the optical clear adhesive 23 is disposed at the non-incident side of the first light guide plate 20 for preventing the light distribution pattern of the incident light to be adversely affected by the optical clear adhesive 23. It is noted that the non-incident side of the first light guide plate 20 is the side of the first light guide plate 20 that is not disposed adjacent to the first light bar, as shown in FIG. 1, i.e., it is the side that is arranged parallel to the third side 101 of the first back bezel 10.

In FIG. 1 and FIG. 5, the display apparatus of the present invention further comprises: a cover 22, that is disposed between the first back bezel 10 and the frame 17. It is noted that the cover 22 is arranged covering the first light bar 16, and an extension 220 of the cover 22 is arranged covering a portion of the first light guide plate 20. By the disposition of the cover 22, the first light guide plate 20 can be fixed while preventing the first light-emitting diodes 161 of the first light bar 16 from any light-leaking.

In FIG. 1 and FIG. 5, the display apparatus of the present embodiment further comprises: an outer frame, that is provided for enabling the second back bezel 11, the second light bar 12, the reflector 13, the second light guide plate 14, the optical film set 15, the first light bar 16, the frame 17, the first light guide plate 20, the display panel 21, and the cover 22 to be sandwiched between the out frame 18 and the first back bezel 10. In this embodiment, the out frame 18 is arranged covering the first back bezel 10 and a portion of the first light guide plate 20.

As shown in FIG. 1, in a condition when the display apparatus of the present embodiment is enabled to display a two-dimensional image, only the second light bar 12 is activated to emit light to the second light guide plate 14, whereas the light can further be guided to the display panel 21 via the optical film set 15 by the second light guide plate 14 for allowing a two-dimensional image to be displayed on the display panel 21. Nevertheless, the first light bar 16 can simultaneously be activated, but the light emitted therefrom is used for shadow elimination or light enhancement.

On the other hand, in a condition when the display apparatus of the present embodiment is enabled to display a three-dimensional image, the first light bar 16 is activated to emit light to the first light guide plate 20, whereas the light can further be guided to the display panel 21 by the first light guide plate 20 for allowing a three-dimensional image to be displayed on the display panel 21.

Thus, by the switching between the first and the second light bars as light sources, the display apparatus of the present invention can be used for either two-dimensional or three-dimensional displaying at will.

In addition, as there is at least one first light-emitting diodes 161 being disposed outside an extension line E of the fourth side 211 of the display area 215, is used for providing supplemental lighting to the periphery of the display panel 21, so as to improve the brightness uniformity of the display apparatus.

Moreover, by the projection formed on the frame, the first light-emitting diodes can be prevented from colliding to the first light guide plate and thus being damaged by the collision.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. A display apparatus, comprising:
a first back bezel with a first side;
a first light guide plate, disposed above the first back bezel;
a first light bar, disposed above the first side of the first back bezel and also disposed between the first light guide plate and the first back bezel; and
a display panel, comprising a display area with a second side, while being disposed above the first light guide plate;
wherein, the first light bar includes a plurality of first light-emitting diodes, and at least one of the first light-emitting diodes is formed with a length L, two of the first light-emitting diodes disposed farthest apart from each other by a distance W1; and the second side of the display area is disposed adjacent to the first side, and a length of the second side is W2, W2 is smaller than W1, and the difference between W1 and W2 is greater than L.

2. The display apparatus of claim 1, wherein the display panel is adhered to the first light guide plate.

3. The display apparatus of claim 2, further comprising:
an optical clear adhesive, sandwiched between the display panel and the first light guide plate.

4. The display apparatus of claim 1, further comprising:
a frame disposed between the first light guide plate and the first back bezel, the frame comprising a projection;
wherein, the first light bar further comprises a first bar-shaped substrate that is provided for the plurality of first light-emitting diodes to be disposed thereon, the projection disposed between the first bar-shaped substrate and the first light guide plate; and the thickness of the projection is not smaller than the thickness of the first light-emitting diodes.

5. The display apparatus of claim 1, further comprising:
a second light guide plate, disposed on the first back bezel; and
at least a optical film, each disposed between the first light guide plate and the second light guide plate.

6. The display apparatus of claim 5, further comprising:
a second light bar;
wherein, the first back bezel is further comprising a third side connected to the first side, and the second light bar to be disposed above the third side at a position corresponding to the second light guide plate.

7. The display apparatus of claim 4, wherein the frame further comprises: a supporting portion and the first light guide plate disposed thereon, a vertical distance between a lower surface of the first light guide plate and a bottom surface of the first back bezel is not larger than a vertical distance between a horizontal center line of the first light-emitting diodes and the bottom surface, and a vertical distance between an upper surface of the first light guide plate and the bottom surface of the first back bezel is not smaller than the vertical distance between the horizontal center line of the first light-emitting diodes and the bottom surface.

8. The display apparatus of claim 1, wherein the first light guide plate includes a plurality of stripes, and the distance between two of the plural stripes spaced farthest apart from each other is smaller than W1.

9. The display apparatus of claim 1, further comprising:
A cover, disposed between the first back bezel and the frame while being formed with an extension that is arranged covering a portion of the first light guide plate.

10. The display apparatus of claim 1, further comprising:
an outer frame, covering the first back bezel and a portion of the first light guide plate.

11. The display apparatus of claim 5, wherein the second light guide plate is disposed between the first back bezel and the first light guide plate.
